(19) United States
(12) Patent Application Publication
(10) Pub. No.: US 2011/0195674 A1
(43) Pub. Date: Aug. 11, 2011

(54) METHOD AND DEVICE FOR ESTABLISHING A ONE-WAY COMMUNICATION SESSION

(75) Inventors: Chao-ping Tung, Flower Mound, TX (US); Zhaohan Zhou, Pudong (CN); Yanbing Yu, Plano, TX (US); Feng Mo, Lewisville, TX (US)

(73) Assignee: MURATA MANUFACTURING CO., LTD., Nagaokakyo-shi (JP)

(21) Appl. No.: 12/700,938

(22) Filed: Feb. 5, 2010

(51) Int. Cl. H04B 1/38

(52) U.S. Cl. 455/90.2

(57) ABSTRACT

A method of establishing a one-way communication session from a first device to a second device includes transmitting initiation data to the second device to establish the one-way communication session, transmitting communication data to the second device, and terminating the one-way communication session. The initiation data causes the second device to receive the communication data and prevents the second device from transmitting communication data to the first device until after the one-way communication session has been terminated.

### BACKGROUND OF THE INVENTION

1. Field of the Invention

The present invention relates to establishing one-way communications over a session initiation protocol (SIP) based network. More specifically, the present invention relates to establishing one-way communication over an SIP-based network without using a push-to-talk (PTT) server by using standard SIP fields.

2. Description of the Related Art

PTT communications are most often used in group communication where groups of three or more users intend to communicate simultaneously amongst each other. Typically, these PTT communications are controlled through the use of a push button on a device that a user presses when he wants to speak. Once this push button is pressed, the device sends a service request to a communications network. The network will then either reject the service request or allocate communication resources to the device based on various criteria, such as priority of the requesting device, what resources are available, etc. If the service request is accepted, a connection will be established between the users of the group so that audio communication between the requesting user and the rest of the group takes place. Then, when the requesting user is finished talking and releases the button, the device will transmit a release message to the network, and the connection will be terminated.

An example of such a PTT system is shown in U.S. Patent Application Publication 2003/0053434. In this system, users are able to communicate with one another through a Push-to-Talk Multicast gateway, as shown in FIG. 1 of U.S. Patent Application Publication 2003/0053434. However, this system is network-centric, relying upon a Wireless Local area network Mobile Radio Service Controller (WLMRSC) to manage the connections between the users. The reliance on a WLMRSC increases the amount of required equipment and the costs of using this PTT system.

Recently systems for performing PTT communications on a one-to-one basis have been proposed. U.S. Pat. No. 7,058,042 teaches an example of such a PTT system. In this system an IP communication service layer is provided over the top of a standard mainstream cellular radio network. This layer relies on a call processing server (CPS) to communicate PTT calls between two separate mobile stations. This system uses the Real-time Transport Protocol (RTP) with embedded signaling to establish one-to-one communications over the cellular radio network. It first sends a leader packet containing the caller's identity information including a special payload number through the network to a receiver. The receiver then responds by sending a positive acknowledgement packet to a communications server in response to receiving the leader packet. If the server does not receive this positive acknowledgment packet it will timeout and send a negative acknowledgement to the caller. However, if the positive acknowledgement packet is received, a connection between the caller and receiver will be initiated. However, this system also relies on a network server, which increases the amount of required equipment and the costs of using this PTT system.

### SUMMARY OF THE INVENTION

To overcome the problems described above, preferred embodiments of the present invention provide a method and device for establishing a one-way communication session without having to modify existing network and receiver hardware and with reduced costs because a network server, or any other network controlling equipment, is not used.

According to a preferred embodiment of the present invention, a method of establishing a one-way communication session from a first device to a second device includes transmitting initiation data to the second device to establish the one-way communication session transmitting communication data to the second device, and terminating the one-way communication session. The initiation data causes the second device to receive the communication data and prevents the second device from transmitting communication data to the first device until after the one-way communication session has been terminated.

The method preferably further includes waiting to receive a first acknowledgement message from the second device after transmitting the initiation data. The communication data is preferably transmitted after receiving the first acknowledgement message. The method preferably further includes transmitting a second acknowledgement message from the first device to the second device after receiving the first acknowledgement message and before transmitting the communication data. The initiation data and the communication data are preferably transmitted to the second device without using a push-to-talk server.

The method preferably further includes determining an address for establishing communication with the second device either from a user of the first device or from memory of the first device, without communicating with a device external to the first device. The step of transmitting is preferably initiated by pushing a button on the first device. The step of terminating is preferably initiated by releasing a button on the first device. The step of transmitting the initiation data preferably uses a session initiation protocol (SIP) message to transmit the initiation data. The initiation data preferably includes a send-only SIP command. The step of transmitting the initiation data and the communication data preferably uses Real-time Transport Protocol (RTP) or Secure Real-time Transport Protocol (SRTP) to transmit the communication data.

According to a preferred embodiment of the present invention, a communication device includes a transmission device arranged to transmit initiation data to a second communication device to establish a one-way communication session, to transmit communication data to the second communication device, and to terminate the one-way communication session. The initiation data causes the second communication device to receive the communication data and prevents the second communication device from transmitting communication data to the communication device until after the one-way communication session has been terminated.

The transmission device is preferably arranged to wait to receive a first acknowledgement message from the second communication device after transmitting the initiation data. The communication data is preferably transmitted after the communication devices receive the first acknowledgement message. The transmission device is preferably arranged to transmit a second acknowledgement message to the second communication device after receiving the first acknowledgement message and before transmitting the communication data. The transmission device is preferably arranged to transmit the initiation data and the communication data to the second communication device without using a push-to-talk server.

The transmission device is preferably arranged to determine an address for establishing communication with the second communication device either from a user of the communication device or from memory of the communication device, without communicating with a device external to the communication device. The communication device preferably further includes a button arranged to transmit the initiation data to establish the one-way communication session when pushed. The communication device preferably further includes a button arranged to terminate the one-way communication session when released. The transmission device is preferably arranged to use a session initiation protocol (SIP) message to transmit the initiation data. The initiation data preferably includes a send-only SIP command. The transmission device is preferably arranged to use Real-time Transport Protocol (RTP) or Secure Real-time Transport Protocol (SRTP) to transmit the communication data.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a diagram that illustrates the initiation of a media session in accordance with a preferred embodiment of the present invention.

FIG. 2 is a diagram that illustrates an establishment of a media session in accordance with a preferred embodiment of the present invention.

FIG. 3 is a diagram that illustrates the establishment and termination of a media session in accordance with a preferred embodiment of the present invention.

### DETAILED DESCRIPTION OF PREFERRED EMBODIMENTS

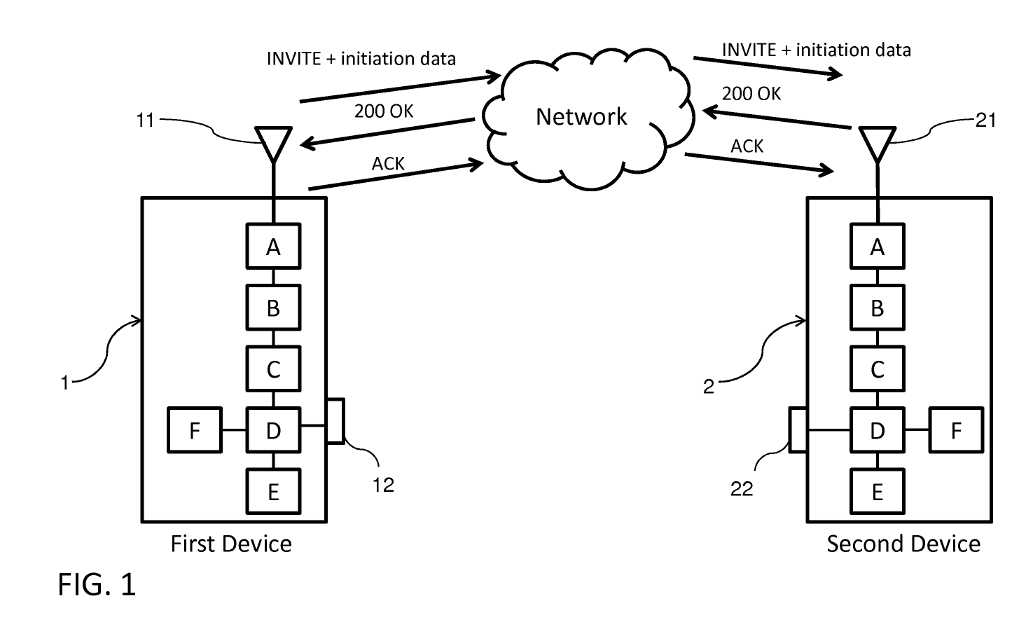

The preferred embodiments of the present invention are discussed below with respect to FIGS. 1-3. First, a description of the process of connecting a first communications device to a second communications device will be described. Then, the specific steps in the process of connecting the communications devices will be described. In the preferred embodiments of the present invention, these connections are performed entirely by the communications devices without any need for an external network-based controller either to gather information from the communications devices or to make any hand-off decisions.

FIG. 1 shows a first device 1 that could be, for example, a wireless communications device and that includes an interface for communicating with a second device 2 over a network. The second device 2 could also be, for example, a wireless communications device. Both of the first 1 and second 2 devices are preferably VoIP handsets. However, any suitable device can be used that uses SIP. The network is preferably capable of performing VoIP communications, but any suitable communication network could be used that supports SIP. For example, the network could be the internet, a wireless local area network (WLAN), or any other suitable network that supports internet protocol (IP). It is also possible not to use a network and for the first 1 and second 2 devices to communicate directly with each other.

Each of the first 1 and second 2 devices can perform one-way communication, which is typically a PTT communication. One-way communication includes establishing a one-way communication session, which is typically a PTT session, between the first 1 and second 2 devices in which communication data is transmitted from the first device 1 to the second device 2 while communication data cannot be transmitted from the second device 2 to the first device 1 or in which communication data is transmitted from the second device 2 to the first device 1 while communication data cannot be transmitted from the first device 1 to the second device 2. Below, one-way communication from the first device 1 to the second device 2 is discussed. However, it should be understood that one-way communication from the second device 2 to the first device 1 is also possible. It should also be understood that communication data includes audio data, video data, or other suitable communication data.

The first 1 and second 2 devices each have a transmission device that preferably includes an antenna 11, 21, an RF processing section A, a baseband processing section B including MAC (Medium Access Control), a CPU C, interface D, memory E, and power supply F. The first 1 and second 2 devices each include a push button 12, 22 connected to the interfaces D.

A user of the first device 1 preferably initiates a one-way communication session by holding down a push button 12 on the first device 1. However, it is possible to use other suitable methods or mechanisms to initiate the one-way communication session. Once the push button 12 is triggered, the first device 1 transmits a message to the second device 2. The message from the first device 1 to the second device 2 can be sent over a network or can be directly sent.

The location or address, e.g. IP address, phone number, and SIP uniform resource identifier (URI), of the second device 2 can be stored in or can be inputted into the first device 1. The one-way communication session is typically only established between two different devices, e.g. the first 1 and second 2 devices, at a time. If a user of the first device 1 desires to communicate with a third device (not shown) different from the second device 2, then the user will need to establish another one-way communication session between the first device 1 and the third device.

The message transmitted from the first device 1 to the second device 2 is preferably an SIP INVITE message that includes special initiation data that indicates that a PPT or a one-way communication session is being requested to be established. The initiation data is preferably included in the header of the SIP INVITE message. For example, the initiation data could be embedded in the “Subject” field or the “display name” part of the uniform resource identifier (URI) in the “To:” or “From:” field of the SIP INVITE message.

An example SIP INVITE message following the standards of RFCC 3261 is provided below in which the initiation data “SyChipPTT” is included in the From: field and the initiation data “SyChipPTT session ZXYKLMN01267” is included in the Subject: field:

INVITE sip:192.168.1.36 SIP/2.0
From: “SyChipPTT”<sip:2016@myvsp.com>;tag=12345
To: <sip:192.168.1.36>
Call-ID: 123456
CSeq: 1 INVITE
Via: SIP/2.0/UDP 192.168.1.40:5060;rport;branch=z9hG4bK-123456
Subject: SyChipPTT session ZXYKLMN01267
Max-Forwards: 70
Supported: replaces
Contact: <sip:2016@192.168.1.40:5060>
Content-Type: application/sdp
Content-Length: 207
v=0
o=0202500004 24 24 IN IP4 192.168.1.40
s=-
c=IN IP4 192.168.1.40
t=0 0
m=audio 49152 RTP/AVP 0 8 101
a=rtpmap:0 PCMU/8000
a=rtpmap:8 PCMA/8000
a=rtpmap:101 telephone-event/8000
a=fmtp:101 0-15.

It is possible to use only the initiation data “SyChipPTT” included in the From: field, only the initiation data “SyChipPTT session ZXYKLMN01267” included in the Subject: field, or both the initiation data “SyChipPTT” included in the From: field and the initiation data “SyChipPTT session ZXYKLMN01267” included in the Subject: field. The initiation data is not limited to the phrases “SyChipPTT” or “SyChipPTT session ZXYKLMN01267” and can take any readily-recognized form.

Alternatively, the SIP attributes “a=sendonly” can optionally be included in the session description protocol (SDP) body. The SIP INVITE message, as shown by the upper arrow in FIG. 1, is preferably sent over the network to the second device 2. However, it is also possible that the SIP INVITE message is sent directly from the first device 1 to the second device 2.

After the first device 1 transmits the SIP INVITE message, one or two acknowledgement messages can transmitted between the first 1 and second 2 devices. Typically, the second device 2 transmits a first acknowledgement message to the first device 1, and then, the first device 1 transmits a second acknowledgement message to second device 2. However, it is possible to send only the first acknowledgement message or not to send any acknowledgement messages.

When the second device 2 receives the SIP INVITE message including the initiation data, the second device 2 is informed that a one-way communication session is being transmitted. After receiving the initiation data, the second device 2 mutes its input and acknowledges that a one-way communication session has been established by sending a 200 OK message (first acknowledgement message) to the first device 1. This 200 OK message is shown by the middle arrow in FIG. 1. After sending the SIP INVITE message, the first device 1 preferably waits until it receives the 200 OK message from the second device 2. When the first device 1 receives the 200 OK message, the first device 1 responds by sending an ACK message (second acknowledgment message) shown by the bottom arrow to the second device 2 to indicate that the one-way communication session has been established. Then, the first device 1 transmits the communication data to the second device 2. The second device 2 automatically receives the communication data, i.e., automatically answers the one-way call from the first device 1. As long as the user of the first device 1 holds down the push button, the one-way communication session between the first 1 and second 2 devices will be maintained.

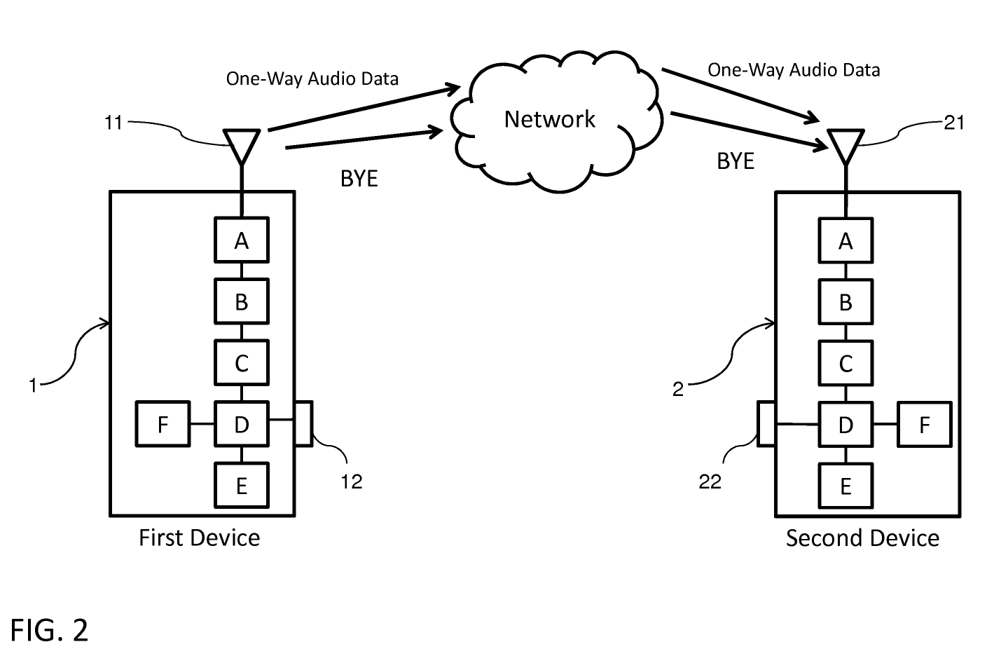

When the push button is pressed down, the first device 1 performs the steps discussed above and shown in FIG. 1 and then un-mutes the input of the first device 1 while disabling the output. Any communication data input into the first device 1 will then be transmitted to the second device 2. FIG. 2 shows that the communication data is transmitted through a network. However, it is also possible that the communication data is transmitted directly between the first 1 and second 2 device. As shown in FIG. 2, the one-way communication session between the first 1 and second 2 device is established by the disabling of the input of the second device 2 and then transmitting the communication data, which is typically audio data, from the first device 1 to the second device 2. The communication data is preferably sent by RTP or secure RTP (SRTP), but can be sent using any suitable protocol. The one-way communication session continues until the user of the first device 1 chooses to terminate the connection by, for example, releasing the push button 12. It is possible to use a toggle arrangement in which the establishment of the one-way communication session is caused by the push and release of the push button 12 and the termination of the one-way communication session is caused by a second push and release of the push button 12. It is also possible for the establishment and/or the termination of the one-way communication session to be triggered by some event. When the user of the first device 1 chooses to terminate the one-way communication session between the first 1 and second 2 devices, the first device 1 will send a BYE message through the network to the second device 2. When the second device receives this BYE message, terminate the one-way communication session between the first 1 and second 2 devices.

Accordingly, it is possible to implement a one-way communication system in a preexisting communications network without the need for any network support by relying entirely on the SIP-based control hardware present in the first 1 and second 2 devices. Thus, one-way communication can be performed over networks that have no hardware that provide PTT capabilities.

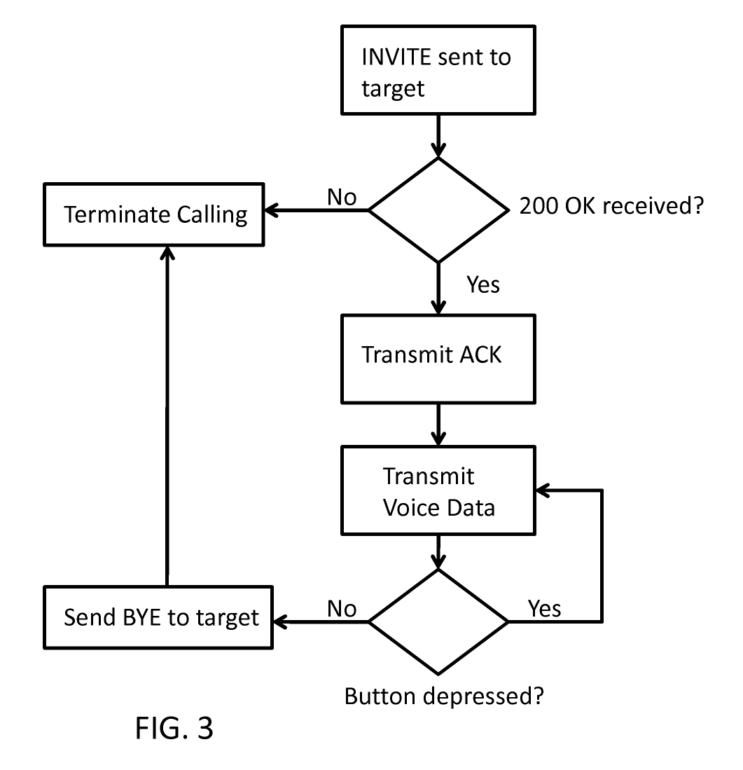

FIG. 3 shows a flow chart of the processes performed by the first device 1 in establishing the connection between the first 1 and second 2 devices. First, the first device 1 sends a SIP INVITE message including initiation data that indicates that a PPT session is being requested to be established to the second device 2. Then the first device 1 waits for a 200 OK message to be sent from the second device 2 to the first device 1. If the first device 1 does not receive this 200 OK message within a predetermined amount of time, the first device 1 will cancel the one-way communication session attempt and indicate to the user of the first device 1 that the one-way communication session attempt failed.

If the first device 1 receives the 200 OK message, then the first device 1 will send an ACK message to the second device 2 acknowledging that the one-way communication session has been started. After sending this ACK message, the first device 1 will transmit communication data to the second device 2. This transmission of communication data will continue until the user of the first device 1 no longer depresses the push button of the first device 1. Once the user releases the push button, the first device will stop sending data to the second device 2 and will transmit a BYE message to the second device 2. When the second device 2 receives this BYE message, it will terminate the connection between the first device 1 and the second device 2.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A method of establishing a one-way communication session from a first device to a second device, the method comprising the steps of:
transmitting initiation data to the second device to establish the one-way communication session;
transmitting communication data to the second device; and
terminating the one-way communication session; wherein
the initiation data causes the second device to receive the communication data and prevents the second device from transmitting communication data to the first device until after the one-way communication session has been terminated.

2. A method according to claim 1, further comprising the step of waiting to receive a first acknowledgement message from the second device after transmitting the initiation data; wherein
the communication data is transmitted after receiving the first acknowledgement message.

3. A method according to claim 2, further comprising the step of transmitting a second acknowledgement message from the first device to the second device after receiving the first acknowledgement message and before transmitting the communication data.

4. A method according to claim 1, wherein the initiation data and the communication data are transmitted to the second device without using a push-to-talk server.

5. A method according to claim 1, further comprising the step of determining an address for establishing communication with the second device either from a user of the first device or from memory of the first device, without communicating with a device external to the first device.

6. A method according to claim 1, wherein the step of transmitting is initiated by pushing a button on the first device.

7. A method according to claim 1, wherein the step of terminating is initiated by releasing a button on the first device.

8. A method according to claim 1, wherein the step of transmitting the initiation data uses a session initiation protocol message to transmit the initiation data.

9. A method according to claim 8, wherein the initiation data includes a send-only session initiation protocol command.

10. A method according to claim 1, wherein the step of transmitting the initiation data and the communication data uses Real-time Transport Protocol or Secure Real-time Transport Protocol to transmit the communication data.

11. A communication device comprising a transmission device arranged to transmit initiation data to a second communication device to establish a one-way communication session, to transmit communication data to the second communication device, and to terminate the one-way communication session; wherein
the initiation data causes the second communication device to receive the communication data and prevents the second communication device from transmitting communication data to the communication device until after the one-way communication session has been terminated.

12. A communication device according to claim 11, wherein the transmission device is arranged to wait to receive a first acknowledgement message from the second communication device after transmitting the initiation data; wherein
the communication data is transmitted after the communication devices receives the first acknowledgement message.

13. A communication device according to claim 12, wherein the transmission device is arranged to transmit a second acknowledgement message to the second communication device after receiving the first acknowledgement message and before transmitting the communication data.

14. A communication device according to claim 11, wherein the transmission device is arranged to transmit the initiation data and the communication data to the second communication device without using a push-to-talk server.

15. A communication device according to claim 11, wherein the transmission device is arranged to determine an address for establishing communication with the second communication device either from a user of the communication device or from memory of the communication device, without communicating with a device external to the communication device.

16. A communication device according to claim 11, further comprising a button arranged to transmit the initiation data to establish the one-way communication session when pushed.

17. A communication device according to claim 11, comprising a button arranged to terminate the one-way communication session when released.

18. A communication device according to claim 11, wherein the transmission device is arranged to use a session initiation protocol message to transmit the initiation data.

19. A communication device according to claim 18, wherein the initiation data includes a send-only session initiation protocol command.

20. A communication device according to claim 11, wherein the transmission device is arranged to use Real-time Transport Protocol or Secure Real-time Transport Protocol to transmit the communication data.
